(19) United States
(12) Patent Application Publication
(10) Pub. No.: US 2018/0364835 A1
(43) Pub. Date: Dec. 20, 2018

(54) FLEXIBLE DISPLAY DEVICE COMPRISING TOUCH SENSOR AND METHOD FOR MANUFACTURING THE SAME

(71) Applicant: DONGWOO FINE-CHEM CO., LTD., Iksan-si (KR)

(72) Inventors: Dohyoung KWON, Osan-si (KR); Euk Kun YOON, Hwaseong-si (KR)

(73) Assignee: DONGWOO FINE-CHEM CO., LTD., Iksan-si (KR)

(21) Appl. No.: 16/010,928

(22) Filed: Jun. 18, 2018

(30) Foreign Application Priority Data
Jun. 19, 2017 (KR) 10-2017-0077371

(51) Int. Cl. G06F 3/044; B32B 7/12

(52) U.S. Cl. CPC G06F 3/044; B32B 7/12; G06F 2203/04102; B32B 2255/26; B32B 2457/208; B32B 2307/42; G06F 2203/04103

(57) ABSTRACT

The present invention provides a flexible display device comprising a touch sensor and a method for manufacturing the same capable of inhibiting cracks during the transfer of the touch sensor, inhibiting wrinkles, bubbles and cracks during the adhesion between an optical film and the touch sensor, and attaining an ultra-thin touch sensor thereby having excellent bending resistance.

### CROSS REFERENCE TO RELATED APPLICATIONS

This application claims priority based on Korean Patent Application No. 10-2017-0077371, filed Jun. 19, 2017, the content of which is incorporated herein by reference in its entirety.

### TECHNICAL FIELD

The present invention relates to a flexible display device comprising a touch sensor and a method for manufacturing the same. More particularly, the present invention relates to a flexible display device comprising a touch sensor and a method for manufacturing the same capable of inhibiting cracks during the transfer of the touch sensor, inhibiting wrinkles, bubbles and cracks during the adhesion between an optical film and the touch sensor, and attaining an ultra-thin touch sensor thereby having excellent bending resistance.

### BACKGROUND ART

A touch sensor is a device in which, when a user touches an image displayed on the screen with one's finger, a touch pen, or the like, a touch point is grasped in response to such a touch. The touch sensor is manufactured as a structure mounted on a flat display device such as a liquid crystal display (LCD), an organic light-emitting diode (OLED), and the like.

Recently, a development of a flexible display device which can be rolled or bent like a paper gains attention. Accordingly, a touch sensor attached on the flexible display device also requires flexible property.

For a flexible touch sensor, a thin and flexible substrate should be used, but it is difficult to form the touch sensor on such a substrate, and thus the touch sensor is formed using a carrier substrate. Thereafter, a substrate film is attached on the touch sensor, and then the touch sensor is separated from the carrier substrate and attached on a desired flexible display device, and the substrate film is removed. Thereby, the flexible display device to which the touch sensor is attached can be manufactured[Korean Patent Application Publication No. 10-2016-0114317].

Prior pressure-sensitive adhesives (PSA) used for attaching a substrate film on a touch sensor are difficult to control adhesion strength for each process. Accordingly, pressure-sensitive adhesives having low adhesion strength have been used so as to easily separate the substrate film. However, the pressure-sensitive adhesives having low adhesion strength have difficulty in controlling cracks in the transfer process of the touch sensor.

In addition, adhesive films such as an optically clear adhesive (OCA) and a non carrier film (NCF0) which are used for adhering a touch sensor on a flexible display device have the problem of adhesion wrinkles and/or cracks after the adhesion. Further, such adhesive films are as thick as 100 μm, so that it is difficult to attain an ultra-thin touch sensor, and the flexible display devices having the adhesive films have poor bending resistance and flexibility.

Therefore, there is a need to develop techniques for a flexible display device comprising a touch sensor and a method for manufacturing the same capable of inhibiting cracks during the transfer of the touch sensor, inhibiting wrinkles, bubbles and cracks during the adhesion between an optical film and the touch sensor, and attaining an ultra-thin touch sensor thereby having excellent bending resistance.

### DISCLOSURE

### Technical Problem

It is an object of the present invention to provide a flexible display device comprising a touch sensor capable of inhibiting cracks during the transfer of the touch sensor, inhibiting wrinkles, bubbles and cracks during the adhesion between an optical film and the touch sensor, and attaining an ultra-thin touch sensor thereby having excellent bending resistance.

It is another object of the present invention to provide a method for manufacturing the flexible display device.

### Technical Solution

In accordance with one aspect of the present invention, there is provided a flexible display device comprising an optical film; a UV curable adhesive formed on the optical film; a touch sensor attached on the UV curable adhesive; and a transfer film attached on the touch sensor with a UV reactive pressure-sensitive adhesive.

In accordance with another aspect of the present invention, there is provided a flexible display device comprising an optical film; a UV curable adhesive formed on the optical film; and a touch sensor attached on the UV curable adhesive.

In accordance with still another aspect of the present invention, there is provided a method for manufacturing a flexible display device, comprising the steps of:

(i) attaching a touch sensor to which a transfer film is attached with a UV reactive pressure-sensitive adhesive to an optical film with a UV curable adhesive; and

(ii) irradiating the pressure-sensitive adhesive and the adhesive simultaneously with UV rays to cute the pressure-sensitive adhesive and the adhesive, and removing the transfer film.

### Advantageous Effects

The flexible display device according to the present invention has an ultra-thin touch sensor which is directly attached on an optical film with a UV curable adhesive instead of prior thick adhesive films such as OCA and has no substrate film, thereby having excellent bending resistance and flexibility. Further, the method of manufacturing the flexible display device according to the present invention can inhibit cracks during the transfer of the touch sensor, inhibit wrinkles, bubbles and cracks during the adhesion between the optical film and the touch sensor, and easily remove a transfer film.

### BRIEF DESCRIPTION OF THE DRAWINGS

FIG. 1 is a cross-sectional view showing the structure of the flexible display device according to an embodiment of the present invention.

FIG. 2 is a cross-sectional view showing the structure of the touch sensor in the flexible display device according to an embodiment of the present invention.

FIG. 3 is a cross-sectional view showing the structure of the flexible display device according to another embodiment of the present invention.

FIGS. 4a to 4b schematically show procedures of the method for manufacturing a flexible display device according to an embodiment of the present invention.

### BEST MODE

Hereinafter, the present invention will be described in more detail with reference to the accompanying drawings.

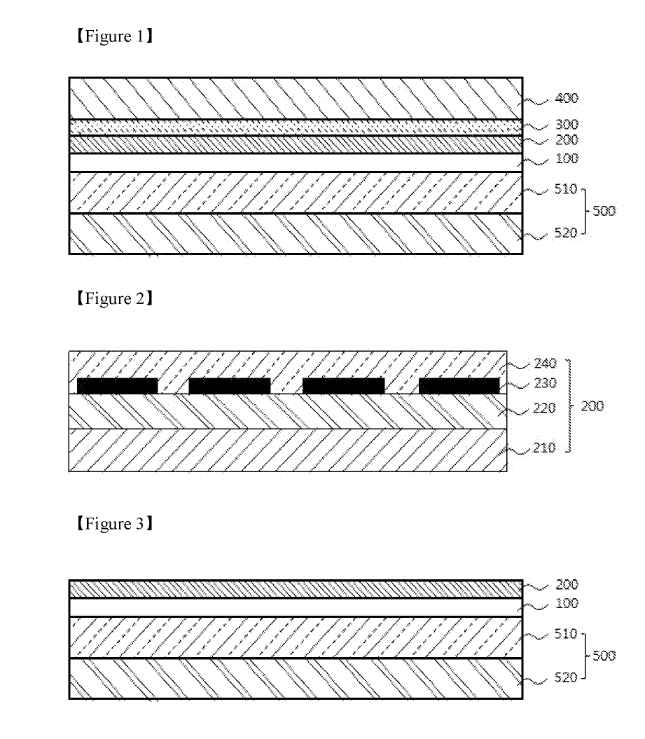

FIG. 1 is a cross-sectional view showing the structure of the flexible display device according to an embodiment of the present invention. With reference to FIG. 1, the flexible display device according to an embodiment of the present invention comprises an optical film 500; a UV curable adhesive 100 formed on the optical film; a touch sensor 200 attached on the UV curable adhesive; and a transfer film 400 attached on the touch sensor with a UV reactive pressure-sensitive adhesive 300.

The flexible display device has a structure in which the touch sensor to which the transfer film is attached with the UV reactive pressure-sensitive adhesive and the optical film are laminated by the UV curable adhesive. Thereby, a single process of UV irradiation can increase the adhesion strength between the optical film and the touch sensor while lowering the adhesion strength of the UV reactive pressure-sensitive adhesive, and thus the transfer film can be easily removed from the touch sensor. Accordingly, it may be effectively used for manufacturing a flexible display device comprising an ultra-thin touch sensor.

The flexible display device may have a total thickness of 140 to 470 μm, particularly 140 to 370 μm. If the total thickness of the flexible display device is less than 140 μm, cracks may occur in the touch sensor during the transfer and/or the adhesion process. If the total thickness of the flexible display device exceeds 470 μm, bending resistance may be deteriorated.

In one embodiment of the present invention, the touch sensor 200 may be a touch sensor in which a separation layer is formed on a carrier substrate to proceed with a process for forming the touch sensor, and the separation layer is used as a wiring coverage layer when separated from the carrier substrate. For example, the touch sensor 200 may be an ultra-thin transfer-type touch sensor having a thickness of 5 to 10 μm.

Specifically,the touch sensor 200 may include a separation layer 210; an electrode pattern layer 230 formed on the separation layer 230; and an insulation layer 240 formed on the electrode pattern layer to cover the electrode pattern layer, as shown in FIG. 2.

The separation layer 210 is made of an organic polymer, and it is applied on a carrier substrate, and separated later from the carrier substrate after the electrode pattern layer is formed thereon.

The separation layer 210 preferably has a peeling strength of 1N/25 mm or less, more preferably 0.1N/25 mm or less. That is, it is preferred that the separation layer 210 is formed from a material that can maintain a physical force applied during separation of the separation layer 210 from the carrier substrate within 1N/25 mm, particularly 0.1N/25 mm.

If the peeling strength of the separation layer 210 exceeds 1N/25 mm, it is difficult to cleanly separate the separation layer from the carrier substrate, so the separation layer 210 may be remained on the carrier substrate. Also, cracks may be generated on at least one of separation layer 210, protective layer 220, electrode pattern layer 230 and insulation layer 240.

In particular, the peeling strength of the separation layer 210 is preferred to have 0.1N/25 mm or less since it allows the control of curl generation after separation from the carrier substrate. The curl may deteriorate the efficiency of adhesion and cutting procedures even though it does not affect the function itself of the film touch sensor. Therefore, it is favorable to minimize curl generation.

Also, the separation layer 210 preferably has a thickness of 10 to 1000 nm, more preferably 50 to 500 nm. If the thickness of the separation layer 210 is less than 10 nm, the separation layer may be unevenly formed to induce the formation of uneven electrode pattern, the peeling strength of the separation layer may be locally raised to cause breakage, or curl control in the touch sensor may be failed after the separation layer is separated from the carrier substrate. If the thickness of the separation layer is more than 1000 nm, the peeling strength of the separation layer may not be lowered anymore, and the flexibility may be deteriorated.

An electrode pattern layer 230 is formed on the separation layer 210. The separation layer 210 acts as a layer of covering the electrode pattern layer 230 or as a layer of protecting the electrode pattern layer 230 from external contact, after the separation layer 210 is separated from the carrier substrate.

On the separation layer 210, at least one protective layer 220 may be further formed. Since only the separation layer 210 may be difficult to achieve complete protection of electrode pattern from external contact or impact, at least one protective layer 220 can be formed on the separation layer 210.

The protective layer 220 may comprise at least one of an organic insulating film and an inorganic insulating film and may be formed by way of coating and curing, or deposition.

The electrode pattern layer 230 may be formed on the separation layer 210 or the protective layer 220. The electrode pattern layer 230 may comprise a sensing electrode that senses touch operation, and a pad electrode formed at one end of the sensing electrode. The sensing electrode may comprise an electrode for sensing touch operation and a wiring pattern connected to the electrode.

The electrode pattern layer 230 may be a transparent conductive layer, and may be formed from at least one selected from the group consisting of a metal, a metal nanowire, a metal oxide, carbon nanotube, graphene, a conductive polymer and a conductive ink.

The electrode pattern layer preferably has the pattern structure used in capacitance mode such as mutual-capacitance mode and self-capacitance mode.

The mutual-capacitance mode may have a grid electrode structure of a horizontal axis and a vertical axis. The point of intersection between electrodes on the horizontal axis and the vertical axis may have a bridge electrode. Alternatively, each electrode pattern layer on the horizontal axis and the vertical axis may be formed and each of them may be electrically apart from each other.

The self-capacitance mode may have an electrode layer structure that recognizes the change of capacitance using one electrode in each position.

On the electrode pattern layer 230, the insulation layer 240 is formed to inhibit the corrosion of the electrode pattern and protect the surface of the electrode pattern. The insulation layer 240 fills a gap in the electrode or the wiring and it is preferably formed to have a certain thickness. That is, the insulation layer is preferably planarized on the opposite surface of the surface in contact with the electrode pattern layer 230 so that the uneven part of the electrode is not emerged.

The insulation layer may be formed from any organic insulating material, and a thermosetting or UV curable organic polymer is preferred.

The touch sensor may have a pad electrode electrically connected with a circuit board. The circuit board may be a flexible printed circuit board (FPCB) and functions to electrically connect the touch sensor with a touch switch circuit.

In one embodiment of the present invention, the carrier substrate may be a glass, but is not limited thereto. That is, other kinds of substrate may be used as the carrier substrate if they are heat-resistant materials that can endure a process temperature for electrode formation and maintain planarization without deformation at a high temperature.

In one embodiment of the present invention, the UV reactive pressure-sensitive adhesive 300 may be obtained by adding a photopolymerizable compound and a photoinitiator to a pressure-sensitive adhesive which is conventionally used in the art.

The UV reactive pressure-sensitive adhesive exhibits high adhesion strength before UV irradiation, and lowered adhesion strength after UV irradiation, thereby reducing crack generation during the transfer of touch sensor. In particular, in the step of attaching the transfer film to the touch sensor formed on the carrier substrate and separating the carrier substrate, the UV reactive pressure-sensitive adhesive imparts higher adhesion strength than the adhesion strength between the touch sensor and the carrier substrate, thereby inhibiting crack generation. In the step of removing the transfer film, the photopolymerizable compound and the photoinitiator perform photopolymerization reaction by UV irradiation and thus the adhesion strength is lowered by the curing shrinkage, so that the transfer film can be easily removed.

The UV reactive pressure-sensitive adhesive may have a thickness of 5 to 50 μm. If the thickness of the UV reactive pressure-sensitive adhesive is less than 5 μm, it is difficult to control the initial adhesion strength before UV irradiation to 1N/25 mm or higher, and cracks may occur in the touch sensor during the transfer. If the thickness exceeds 50 μm, indentations may occur by the elasticity of the pressure-sensitive adhesive during the transfer process to cause cracks in the touch sensor after the transfer.

In one embodiment of the present invention, the pressure-sensitive adhesive may comprise an acryl-based copolymer and a cross-linking agent.

The acryl-based copolymer may be a copolymer of a (meth)acrylate monomer having an alkyl group of 1 to 12 carbon atoms and a polymerizable monomer having a crosslinkable functional group.

Herein, the (meth)acrylate refers to acrylate and methacrylate.

Specific examples of the (meth)acrylate monomer having an alkyl group of 1 to 12 carbon atoms include n-butyl (meth)acrylate, 2-butyl (meth)acrylate, t-butyl (meth)acrylate, 2-ethylhexyl (meth)acrylate, ethyl (meth)acrylate, methyl (meth)acrylate, n-propyl (meth)acrylate, isopropyl (meth)acrylate, pentyl (meth)acrylate, n-octyl (meth)acrylate, isooctyl (meth)acrylate, nonyl (meth)acrylate, decyl (meth)acrylate, lauryl (meth)acrylate, and the like, and they can be used alone or in combination of two or more.

The polymerizable monomer having a crosslinkable functional group is a component for imparting durability and curability by reinforcing the cohesive force or adhesive force by a chemical bond. For example, a monomer having a hydroxyl group and a monomer having a carboxyl group may be exemplified, and they can be used alone or in combination of two or more.

Examples of the monomer having a hydroxyl group include 2-hydroxyethyl (meth)acrylate, 2-hydroxypropyl (meth)acrylate, 2-hydroxybutyl (meth)acrylate, 4-hydroxybutyl (meth)acrylate, 6-hydroxyhexyl (meth)acrylate, 2-hydroxyethylene glycol (meth)acrylate, 2-hydroxypropylene glycol (meth)acrylate, hydroxyalkylene glycol (meth)acrylate having an alkylene group of 2 to 4 carbon atoms, 4-hydroxybutyl vinyl ether, 5-hydroxypentyl vinyl ether, 6-hydroxyhexyl vinyl ether, 7-hydroxyheptyl vinyl ether, 8-hydroxyoctyl vinyl ether, 9-hydroxynonyl vinyl ether, 10-hydroxydecyl vinyl ether, and the like.

Examples of the monomer having a carboxyl group include a monovalent acid such as (meth)acrylic acid, crotonic acid and the like; a divalent acid such as maleic acid, itaconic acid, fumaric acid, and an monoalkyl ester thereof; 3-(meth)acryloyl propionic acid; a succinic anhydride ring-opening adduct of 2-hydroxyalkyl (meth)acrylate having an alkyl group of 2 to 3 carbon atoms, a succinic anhydride ring-opening adduct of hydroxyalkylene glycol (meth)acrylate having an alkylene group of 2 to 4 carbon atoms, a compound obtained by a ring-opening addition of succinic anhydride to a caprolactone adduct of 2-hydroxyalkyl (meth)acrylate having an alkyl group of 2 to 3 carbons, and the like.

The acryl-based copolymer may further contain, in addition to the above-mentioned monomers, other polymerizable monomers within a range that does not deteriorate the adhesive strength, for example, in an amount of 10% by weight or less based on the total amount.

The method for preparing the copolymer is not particularly limited, and it can be prepared by methods, which are commonly used in the art, such as bulk polymerization, solution polymerization, emulsion polymerization or suspension polymerization, and solution polymerization is preferable. Further, a solvent, a polymerization initiator, a chain transfer agent for molecular weight control, and the like, which are commonly used in polymerization, can be used.

The acryl-based copolymer commonly has a weight average molecular weight (in terms of polystyrene, Mw) measured by gel permeation chromatography (GPC) of 50,000 to 2,000,000, preferably 400,000 to 2,000,000. If the weight average molecular weight is less than 50,000, cohesive force between the copolymers is insufficient, thereby causing a problem in adhesion durability. If the weight average molecular weight exceeds 2,000,000, a large amount of dilution solvent may be needed in order to secure process property during coating process.

The cross-linking agent is used to enhance adhesion property and durability and to maintain reliability at a high temperature and the form of the adhesive. By way of examples, the cross-linking agent may include, without limitation, isocyanate compounds, epoxy compounds, peroxide compounds, metal chelate compounds, oxazoline compounds, etc. These compounds may be used alone or in combination of two or more. Among these, isocyanate compounds are preferred.

Specifically, diisocyanate compounds such as tolylene diisocyanate, xylene diisocyanate, hexamethylene diisocyanate, 2,4- or 4,4-diphenylmethane diisocyanate; and adducts of polyhydric alcohol compounds such as trimethylolpropane to the diisocyanate compounds may be used.

In addition to the isocyanate cross-linking agent, at least one cross-linking agent selected from the group consisting of melamine derivatives such as hexamethylol melamine, hexamethoxymethyl melamine, hexabutoxymethyl melamine, etc., polyepoxy compounds such as an epoxy compound obtained from condensation of bisphenol A and epichlorohydrin polyglycidyl ether of polyoxyalkylene polyol, glycerol diglycidyl ether, glycerol triglycidyl ether, tetraglycidyl xylene diamine may be further used.

The photopolymerizable compound added to the pressure-sensitive adhesive is photopolymerized by UV irradiation thereby reducing the peeling strength of the adhesive. In particular, a polyfunctional acrylate may be used. Examples of the polyfunctional acrylate include hexanediol di(meth)acrylate, (poly)ethylene glycol di(meth)acrylate, (poly)propylene glycol di(meth)acrylate, neopentyl glycol di(meth)acrylate, pentaerythritol di(meth)acrylate, trimethylolpropane tri(meth)acrylate, tetramethylolmethane tetra(meth)acrylate, pentaerythritol tri(meth)acrylate, pentaerythritol tetra(meth)acrylate, dipentaerythritol monohydroxy penta(meth)acrylate, dipentaerythritol hexa(meth)acrylate, epoxy (meth)acrylate, polyester (meth)acrylate, urethane (meth)acrylate, and the like. These polyfunctional acrylates can be used alone or in combination of two or more.

The photoinitiator may include, without limitation, benzoin, benzoin methyl ether, benzoin ethyl ether, benzoin isopropyl ether, benzoin n-butyl ether, benzoin isobutyl ether, acetophenone, dimethylamino acetophenone, 2,2-dimethoxy-2-phenyl acetophenone, 2,2-diethoxy-2-phenyl acetophenone, 2-hydroxy-2-methyl-1-phenylpropan-1-one, 1-hydroxycyclohexyl phenyl ketone, 2-methyl-1-[4-(methylthio)phenyl]-2-morpholino-propan-1-one, 4-(2-hydroxyethoxy)phenyl-2-(hydroxy-2-propyl) ketone, benzophenone, p-phenyl benzophenone, 4,4′-diethylamino benzophenone, dichloro benzophenone, 2-methyl anthraquinone, 2-ethyl anthraquinone, 2-t-butyl anthraquinone, 2-amino anthraquinone, 2-methyl thioxanthone, 2-ethyl thioxanthone, 2-chloro thioxanthone, 2,4-dimethyl thioxanthone, 2,4-diethyl thioxanthone, benzyl dimethyl ketal, acetophenone dimethyl ketal, p-dimethylamino benzoic acid ester, oligo[2-hydroxy-2-methyl-1-[4-(1-methylvinyl)phenyl]propanone], 2,4,6-trimethylbenzoyl-diphenyl-phosphine oxide, and the like. These photoinitiators can be used alone or in combination of two or more.

In addition to the above-mentioned components, the UV reactive pressure-sensitive adhesive, if necessary, may further comprise various additives such as an antioxidant, a tackifier, an anti-aging agent, a filler, a colorant and the like.

In one embodiment of the present invention, the transfer film 400 may support and protect the touch sensor 200 during the transfer of the touch sensor.

The transfer film 400, for example, may be made of cyclo-olefin polymer (COP), polycarbonate, polyethylene terephthalate (PET), poly methyl methacrylate, polyimide, polyethylene naphthalate, polyethersulfone and the like.

The thickness of the transfer film 400 may be 75 to 200 μm. If the thickness of the transfer film is less than 75 μm, the tension is extremely high during the transfer of the touch sensor, so that cracks may be generated in the touch sensor. If the thickness exceeds 200 μm, the elasticity modulus of the transfer film may be too high to make it difficult to control the peeling process.

In one embodiment of the present invention, the optical film 500 may be a polarizing plate 510 and/or a display panel 520.

The polarizing plate 510 includes an elongation-type or coating-type polarizer, and may include a protective film laminated on at least one side of the polarizer as needed.

The display panel 520 may be, for example, liquid crystal display (LCD) panel, plasma display panel (PDP), organic light emitting diode (OLED) panel, electrophoretic display (EPD) panel, and the like.

The optical film, for example, the polarizing plate may have a thickness of 50 to 210 μm. The thicker the optical film is, the lower the bending resistance may be.

In one embodiment of the present invention, the UV curable adhesive 100 may comprise a photopolymerizable compound and a photopolymerization initiator.

The UV curable adhesive generates less wrinkles or bubbles when applied on the touch sensor and/or the optical film and adhered using a roll, since it has a liquid form before UV irradiation. After UV irradiation, the UV curable adhesive is cured to provide excellent adhesion strength between the touch sensor and the optical film. Accordingly, the UV curable adhesive can control the occurrence of wrinkles at the junction of the touch sensor and the optical film and inhibit the occurrence of bubbles and cracks.

The photopolymerizable compound may comprise a radical photopolymerizable compound and/or a cationic photopolymerizable compound.

Examples of the radical photopolymerizable compound may include mono- to hexa-functional monomers. In particular, there are exemplified monofunctional monomers such as methyl (meth)acrylate, allyl methacrylate, 2-ethoxyethyl (meth)acrylate, isodecyl (meth)acrylate, 2-dodecylthioethyl methacrylate, octyl acrylate, 2-methoxyethyl acrylate, hydroxyethyl (meth)acrylate, hydroxypropyl (meth)acrylate, hydroxybutyl (meth)acrylate, isooctyl (meth)acrylate, isodecyl (meth)acrylate, stearyl (meth)acrylate, glycidyl (meth)acrylate, tetrahydrofurfuryl (meth)acrylate, phenoxyethyl (meth)acrylate, urethane acrylate, aminoethyl (meth)acrylate, dimethylaminoethyl (meth)acrylate and the like; difunctional monomers such as 1,3-butanediol di(meth)acrylate, 1,4-butanediol di(meth)acrylate, 1,6-hexanediol di(meth)acrylate, ethylene glycol di(meth)acrylate, bisphenol A-ethylene glycol diacrylate, diethylene glycol di(meth)acrylate, triethylene glycol di(meth)acrylate, polyethylene glycol di(meth)acrylate, propylene glycol di(meth)acrylate, dipropylene glycol di(meth)acrylate, neopentyl glycol di(meth)acrylate, dicyclopentanyl di(meth)acrylate, caprolactone-modified dicyclopentenyl di(meth)acrylate, ethylene oxide-modified phosphoric acid di(meth)acrylate, bis(2-hydroxyethyl)isocyanurate di(meth)acrylate, di(acryloxyethyl) isocyanurate, allylated cyclohexyl di(meth)acrylate, dimethylol dicyclopentane diacrylate, ethylene oxide-modified hexahydrophthalic acid diacrylate, tricyclodecane dimethanol diacrylate, neopentyl glycol-modified trimethylolpropane diacrylate, adamantine diacrylate and the like; trifunctional monomers such as trimethylolpropane tri(meth)acrylate, dipentaerythritol tri(meth)acrylate, propionic acid-modified dipentaerythritol tri(meth)acrylate, pentaerythritol tri(meth)acrylate, propylene oxide-modified trimethylolpropane tri(meth)acrylate, tris(2-hydroxyethyl) isocyanurate tri(meth)acrylate, tris(acryloxyethyl) isocyanurate, glycerol tri(meth)acrylate and the like; tetrafunctional monomers such as diglycerin tetra(meth)acrylate, pentaerythritol tetra(meth)acrylate, di(trimethylolpropane) tetra(meth)acrylate and the like; pentafunctional monomers such as propionic acid-modified dipentaerythritol penta(meth)acrylate and the like; hexafunctional monomers such as caprolactone-modified dipentaerythritol hexa(meth)acrylate and the like. Among them, mono- to tri-functional monomers are preferred. The monomers can be used alone or in combination of two or more.

Examples of the cationic photo-polymerizable compound may include bisphenol-type epoxy resins such as a bisphenol A-type epoxy resin, a bisphenol F-type epoxy resin and the like; novolac-type epoxy resins such as a phenol novolac-type epoxy resin, a cresol novolac-type epoxy resin and the like; an aliphatic epoxy resin, an alicyclic epoxy resin, a naphthalene-type epoxy resin, a polyfunctional epoxy resin, a biphenyl-type epoxy resin, a glycidyl ether-type epoxy resin, a glycidyl ester-type epoxy resin, a glycidyl amine-type epoxy resin; alcohol-type epoxy resins such as a hydrogenated bisphenol A-type epoxy resin; halogenated epoxy resins such as a brominated epoxy resin; epoxy group-containing compounds such as a rubber-modified urethane resin, a urethane-modified epoxy resin, an epoxidized polybutadiene, an epoxidized styrene-butadiene-styrene block copolymer, an epoxy group-containing polyester resin, an epoxy group-containing polyurethane resin, an epoxy group-containing acrylic resin and the like; oxetanyl group-containing compounds such as phenoxymethyl oxetane, 3,3-bis(methoxymethyl)oxetane, 3,3-bis(phenoxymethyl)oxetane, 3-ethyl-3-(phenoxymethyl)oxetane, 3-ethyl-3-(2-ethylhexyloxymethyl)oxetane, 3-ethyl-3-{[3-(triethoxysiyl)propoxy]methyl}oxetane, phenol novolac oxtane, 1,4-bis{[(3-ethyl-3-oxetanyl)methoxy]methyl}benzene and the like. These can be used alone or in combination of two or more.

The photopolymerization initiator is used to enhance efficiency of the curing reaction, and examples thereof include radical photopolymerization initiators such as an acetophenone-based initiator, a benzophenone-based initiator, a thioxanthone-based initiator, a benzoin-based initiator, a benzoinalkylether-based initiator and the like; cationic photopolymerization initiators such as an aromatic diazonium salt, an aromatic sulfonium salt, an aromatic iodonium salt, a benzoin ester of sulfonic acids and the like. Also, as the cationic photopolymerization initiator, there are exemplified commercially available products such as OPUTOMA-SP-151, OPUTOMA-SP-170, OPUTOMA-SP-171 (Asahi Denka Co., Ltd.), Irgacure-261 (Ciba Inc.), San-Aid SI-60L, UVI-6990 (Union Carbide Corporation), BBI-1C3, MPI-103, TPS-103, DTS-103, NAT-103, NDS-103 (Midori Kagaku Co., Ltd.), CPI-110A (San-Agro Ltd.), and the like. These can be used alone or in combination of two or more.

The photopolymerization initiator may be contained in an amount of 0.5 to 10 parts by weight based on 100 parts by weight of the photopolymerizable compound, but is not limited thereto. When the amount is within the above range, curing rate is adequate and durability is excellent.

The UV curable adhesive may further comprise, if necessary, at least one selected from a photo-sensitizer, an antioxidant and the like known in the art.

In accordance with one embodiment of the present invention, process defects generated in prior adhesive films, such as wrinkles, bubbles, cracks and the like, can be controlled by coating the UV curable adhesive 100 on the optical film 500 and then attaching the touch sensor 200 to which the transfer film 400 is attached with the UV reactive pressure-sensitive adhesive 300 thereon.

The UV curable adhesive may be coated using a coating method known in the art without particular limitation. For example, a method such as bar coater, air knife, gravure, reverse roll, kiss roil, spray, blade, die coater, casting, spin coating, etc. can be used.

The coating thickness of the UV curable adhesive is not particularly limited. For example, it be 0.01 to 10 μm, preferably 0.5 to 3 μm, particularly 1 μm.

FIG. 3 is a cross-sectional view showing the structure of the flexible display device according to one embodiment of the present invention. With reference to FIG. 3, the flexible display device according to one embodiment of the present invention comprises an optical film 500; a UV curable adhesive 100 formed on the optical film; and a touch sensor 200 attached on the UV curable adhesive.

In the flexible display device of FIG. 1, UV irradiation increases the adhesion strength between the optical film and the touch sensor, and decreases the adhesion strength of the UV reactive pressure-sensitive adhesive, so that the transfer film can be easily removed from the touch sensor to form the flexible display device of FIG. 3. Accordingly, the flexible display device has the structure in which the touch sensor and the optical film are laminated by the UV curable adhesive, and it is possible to manufacture an ultra-thin touch sensor having no substrate film.

The touch sensor 200, the optical film 500 and the UV curable adhesive 100 are described in the above flexible display device of FIG. 1, and thus a detailed description thereof will be omitted.

The flexible display device may have a total thickness of 60 to 220 μm, particularly 60 to 120 μm. If the total thickness of the flexible display device is less than 60 μm, cracks may occur in the touch sensor during the adhesion process. If the total thickness exceeds 220 μm, bending resistance may be deteriorated.

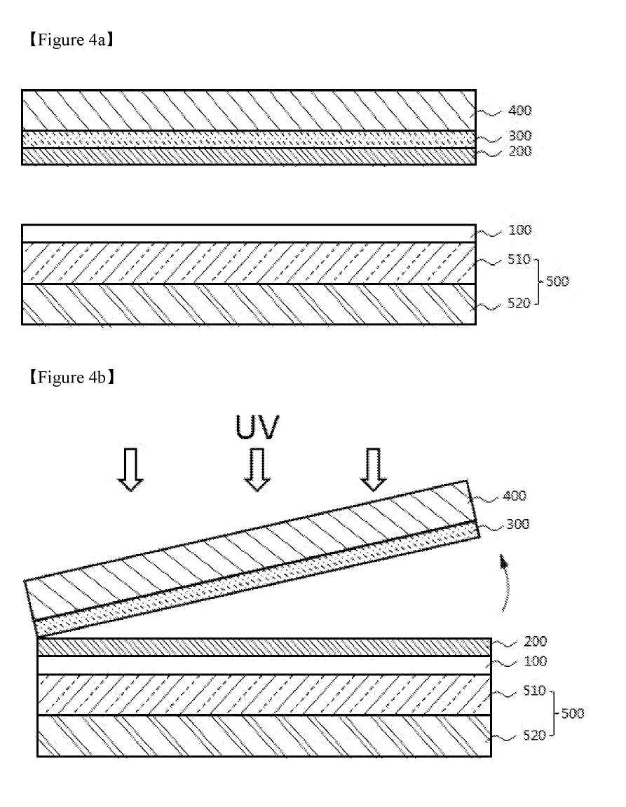

FIGS. 4a to 4b schematically show procedures of the method for manufacturing a flexible display device according to one embodiment of the present invention. With reference to FIGS. 4a to 4b, the method for manufacturing a flexible display device according to one embodiment of the present invention comprises the steps of:

(i) attaching a touch sensor 200 to which a transfer film 400 is attached with a UV reactive pressure-sensitive adhesive 300 to an optical film 500 with a UV curable adhesive 100; and

(ii) irradiating the pressure-sensitive adhesive and the adhesive simultaneously with UV rays to cure the pressure-sensitive adhesive and the adhesive, and removing the transfer film 400.

In accordance with the method for manufacturing a flexible display device according to one embodiment of the present invention, first, the touch sensor 200 to which the transfer film 400 is attached with the UV reactive pressure-sensitive adhesive 300 is attached to the optical film 500 with the UV curable adhesive 100 as shown in FIG. 4a.

After attaching the touch sensor 200 to which the transfer film 400 is attached with the UV reactive pressure-sensitive adhesive 300 to the optical film 500 with the UV curable adhesive 100 as described above, the pressure-sensitive adhesive and the adhesive is irradiated simultaneously with UV rays to cure the pressure-sensitive adhesive and the adhesive, and the transfer film 400 is removed, as shown in FIG. 4b.

The adhesion strength of the UV reactive pressure-sensitive adhesive 300 is lowered and the adhesion strength of the UV curable adhesive 100 is increased by UV irradiation. Accordingly, the removal of the transfer film 400 is easily performed, and the adhesion between the touch sensor and the optical film becomes stronger. That is, a single process of UV irradiation can increase the adhesion strength between the optical film and the touch sensor, while lowering the adhesion strength between the transfer film and the touch sensor.

The touch sensor 200, the UV reactive pressure-sensitive adhesive 300, the transfer film 400, the optical film 500 and the UV curable adhesive 100 are described in the above flexible display device of FIG. 1, and thus a detailed description thereof will be omitted.

Hereinafter, the present invention will be described in more detail with reference to examples, comparative examples and experimental examples. It should be apparent to those skills in the art that these examples, comparative examples and experimental examples are for illustrative purpose only, and the scope of the present invention is not limited thereto.

### EXAMPLES 1 to 4

### Manufacture of Flexible Display Device

Flexible display devices having a laminate structure as shown in FIG. 1 were manufactured, while changing the thicknesses of PET films as the transfer film, as shown in Table 1 below. At this time, a polarizing plate having the thickness of 68 μm was used as the optical film, the UV curable adhesive had the thickness of 1 μm, the touch sensor had the thickness of 7 μm, and the UV reactive pressure-sensitive adhesive had the thickness of 25 μm. The initial peeling strength of the UV reactive pressure-sensitive adhesive used for the flexible display devices was 1 N/25 mm, and the peeling strength was lowered to 0.1 N/25 mm after UV irradiation.

### EXAMPLES 5 to 8

### Manufacture of Flexible Display Device

Flexible display devices were manufactured in the same manner as in Example 1, except that polarizing plates having the thicknesses of 90 μm, 133 μm, 177 μm and 205 μm respectively, were used instead of the polarizing plate having the thickness of 68 μm as the optical film.

### COMPARATIVE EXAMPLES 1 to 2

### Manufacture of Flexible Display Device

Flexible display devices were manufactured in the same manner as in Example 1, except that the thicknesses of the PET films as the transfer film were changed as in Table 1 below.

### COMPARATIVE EXAMPLE 3

### Manufacture of Flexible Display Device

A flexible display device having a structure in which the touch sensor and the optical film were laminated by OCA was manufactured.

At this time, a polarizing plate having the thickness of 68 μm was used as the optical film, and the touch sensor had the thickness of 7 μm.

### EXPERIMENTAL EXAMPLE 1

The flexible display devices manufactured in the above Examples and Comparative Examples were irradiated with UV rays, and the PET films as the transfer film were peeled off. At this time, it was confirmed whether or not cracks were inhibited and peeling process was controlled when the transfer film was peeled off. The results are shown in Table 1 below according to the below criteria.

<Inhibition of Crack Occurrence>

◯: Crack occurrence was inhibited

×: Cracks occurred

<Control of Peeling Process>

◯: It is possible to control peeling process

Δ: It is impossible to control peeling process

TABLE 1

| | Comparative | | | | | Comparative |
|---|---|---|---|---|---|---|
| Category | Example 1 | Example 1 | Example 2 | Example 3 | Example 4 | Example 2 |
| Thickness of | 50 | 75 | 100 | 150 | 200 | 250 |
| transfer film | | | | | | |
| (μm) | | | | | | |
| Crack | X | ◯ | ◯ | ◯ | ◯ | ◯ |
| occurrence | | | | | | |
| Control of | ◯ | ◯ | ◯ | ◯ | ◯ | X |
| peeling | | | | | | |
| process | | | | | | |

As can be seen from Table 1, in the case of the flexible display devices of Examples 1 to 4 according to the present invention, no crack occurred and the peeling process could be controlled when the transfer film was peeled off. On the other hand, in the case of the flexible display devices of Comparative Examples 1 and 2, cracks occurred or the peeling process failed to be controlled.

### EXPERIMENTAL EXAMPLE 2

The flexible display devices manufactured in Examples 1 and 5-8 were irradiated with UV rays and the PET films as the transfer film were peeled off to obtain flexible display devices having a structure in which the touch sensor and the optical film were laminated with the UV curable adhesive.

The above flexible display devices and the flexible display device manufactured in Comparative Example 3 were tested for in-folding and out-folding bending resistance, and the results thereof are shown in Table 2 below. The numbers of folding times showing function defects in the touch sensors of the flexible display devices were measured and the evaluation results are shown according to the below criteria.

At this time, the in-folding test was performed by folding the flexible display device so as to make the sides of the optical film meet, and the out-folding test was performed by folding the flexible display device so as to make the sides of the touch sensor meet.

<In-Folding Evaluation Criteria>

⊚: 200,000 or more

◯: 150,000 or more and less than 200,000

□: 100,000 or more and less than 150,000

Δ: 50,000 or more and less than 100,000

×: less than 50,000

<Out-Folding Evaluation Criteria>

⊚: 50,000 or more

◯: 40,000 or more and less than 50,000

□: 30,000 or more and less than 40,000

Δ: 20,000 or more and less than 30,000

×: less than 20,000

TABLE 2

| | | | | | | Comparative |
|---|---|---|---|---|---|---|
| Category | Example 1 | Example 5 | Example 6 | Example 7 | Example 8 | Example 3 |
| Total | 76 | 98 | 141 | 185 | 213 | 241 |
| thickness (μm) | | | | | | |
| In-folding | ⊚ | ⊚ | ◯ | □ | Δ | X |
| Out-folding | ⊚ | ⊚ | ◯ | □ | Δ | X |

As can be seen from Table 2, in the case of the flexible display devices of Examples 1 and 5-8 using the UV curable adhesive according to the present invention, it was confirmed that the total thicknesses were thinner and bending resistances were more excellent, as compared to the flexible display device of Comparative Example 3 using OCA. Particularly, the total thickness of the flexible display device of Example 1 was as thin as ⅓ of the total thickness of the flexible display device of Comparative Example 3 using OCA. Also, the bending resistance of the flexible display device of Example 1 was twice or more excellent than that of the flexible display device of Comparative Example 3.

Although particular embodiments of the present invention have been shown and described in detail, it will be obvious to those skilled in the art that these specific techniques are merely preferred embodiments and the scope of the invention is not limited thereto. It will be understood by those skilled in the art that various changes and modifications may be made to the invention without departing from the spirit and scope of the invention.

The substantial scope of the present invention, therefore, is to be defined by the appended claims and equivalents thereof.

[Description of Reference Numerals]

| 100: UV curable adhesive | 200: Touch sensor |
|---|---|
| 210: Separation layer | 220: Protective layer |
| 230: Electrode pattern layer | 240: Insulation layer |
| 300: UV reactive pressure-sensitive adhesive | |
| 400: Transfer film | 500: Optical film |
| 510: Polarizing plate | 520: Display panel |

1. A flexible display device comprising:
an optical film;
a UV curable adhesive formed on the optical film;
a touch sensor attached on the UV curable adhesive; and
a transfer film attached on the touch sensor with a UV reactive pressure-sensitive adhesive,

2. The flexible display device according to claim 1, having a total thickness of 140 to 470 μm.

3. The flexible display device according to claim 1, wherein the transfer film has a thickness of 75 to 200 μm.

4. The flexible display device according to claim 1, wherein the touch sensor includes a separation layer; an electrode pattern layer formed on the separation layer; and an insulation layer formed on the electrode pattern layer to cover the electrode pattern layer, and the transfer film is attached on the insulation layer.

5. The flexible display device according to claim 4, wherein the touch sensor further includes a protective layer formed between the separation layer and the electrode pattern layer.

6. The flexible display device according to claim 1, wherein the optical film is a polarizing plate or a display panel.

7. A flexible display device comprising:
an optical film;
a UV curable adhesive formed on the optical film; and
a touch sensor attached on the UV curable adhesive.

8. The flexible display device according to claim 7, having a total thickness of 60 to 220 μm.

9. The flexible display device according to claim 8, having a total thickness of 60 to 120 μm.

10. The flexible display device according to claim 7, wherein the touch sensor includes a separation layer; an electrode pattern layer formed on the separation layer; and an insulation layer formed on the electrode pattern layer to cover the electrode pattern layer, and the separation layer is attached on the UV curable adhesive.

11. The flexible display device according to claim 10, wherein the touch sensor further includes a protective layer formed between the separation layer and the electrode pattern layer.

12. The flexible display device according to claim 7, wherein the optical film is a polarizing plate or a display panel.

13. A method for manufacturing a flexible display device, comprising the steps of:
(i) attaching a touch sensor to which a transfer film is attached with a UV reactive pressure-sensitive adhesive to an optical film with a UV curable adhesive; and
(ii) irradiating the pressure-sensitive adhesive and the adhesive simultaneously with UV rays to cure the pressure-sensitive adhesive and the adhesive, and removing the transfer film.

14. The method according to claim 13, wherein the UV reactive pressure-sensitive adhesive is obtained by adding a photopolymerizable compound and a photoinitiator to a pressure-sensitive adhesive.

15. The method according to claim 14, wherein the UV reactive pressure-sensitive adhesive comprises an acryl-based copolymer, a cross-linking agent, a polyfunctional acrylate, and a photoinitiator.

16. The method according to claim 13, wherein the UV curable adhesive comprises a photopolymerizable compound and a photopolymerization initiator.

17. The method according to claim 13, wherein the optical film is a polarizing plate or a display panel.
